(19) United States
(12) Patent Application Publication
(10) Pub. No.: US 2005/0279320 A1
(43) Pub. Date: Dec. 22, 2005

(54) Method and means for improved efficiency of cylinder deactivation (DODTM) engines

(76) Inventors: Alexander J. Roberts, Rochester, MI (US); Jeffrey J. Allen, Kelkheim-Fischbach (DE); Thomas E. Bolander, Flint, MI (US)

Correspondence Address: KARL F. BARR JR.;General Motors Corporation, Mail Code 482-C23-B21, Legal Staff, P.O. Box 300, Detroit, MI, 48265-3000, US

(21) Appl. No.: 10/872,267

(22) Filed: Jun. 18, 2004

(51) Int. Cl. F02D 17/02

(52) U.S. Cl. 123/198 F

(57) ABSTRACT

A cylinder deactivation (DOD™) engine is provided with features and operated in a manner to increase the cylinder air charges of the operating cylinders in DOD operation with the DOD cylinders cut out. The increased charge air allows higher loading of the STD cylinders extending the range of torque loads and speeds for DOD engine operation without requiring switchover to STD operation wherein all cylinders are in operation. The result is increased overall efficiency by extended operation of the engine in a DOD mode wherein the operating cylinders have higher levels of volumetric efficiency and reduced fuel consumption.

### TECHNICAL FIELD

This invention relates to automotive engines with cylinder deactivation, also known as Displacement on Demand or DOD™ engines, and to a method and means for improving engine efficiency by extending the DOD operating range.

### BACKGROUND OF THE INVENTION

It is known in the art relating to automotive engines to utilize various means to obtain peak torque and power. Among the various devices designed, tuned or set to provide the optimum engine performance are the engine camshaft, fixed or variable valve timing means, an air intake system including manifold plenums and runners, an exhaust system, a supercharger, and a cam phaser. Generally, engine design or tuning is optimized for obtaining peak torque at a relatively high speed, such as 4800 RPM, which generally provides a lower level of volumetric efficiency and torque at lower engine speeds.

In order to increase vehicle fuel efficiency, currently available engines have been modified for operation with cylinder deactivation, also called Displacement on Demand (DOD™), wherein the engine is powered by less than all of the cylinders, generally not less than half, while the remaining DOD cylinders are deactivated by closing their valves and shutting off their fuel supply. Inherently, DOD operation is limited to a lower range of torque loads than standard (STD) operation with all cylinders activated. Thus, when quick vehicle acceleration or high speed operation is called for, the engine is automatically switched over to standard (STD) operation to provide the necessary torque or power. This reduces fuel efficiency because the cylinder loading is reduced to a less efficient level than could be maintained if the engine could continue with DOD operation

### SUMMARY OF THE INVENTION

The present invention provides for modification of a DOD™ engine to extend the range of torque loads in which DOD operation may be continued, so that engine volumetric efficiency and fuel efficiency may be increased. The invention involves redesigning, retuning or modifying components of the engine to provide increased torque and power in the lower speed ranges where a major portion of DOD operation generally takes place. Preferably, optimal tuning also includes increasing DOD torque output also in higher speed ranges so that DOD operation may be continued at higher loads and into a higher speed range for increased engine efficiency and DOD operation performance.

An engine according to the invention is, then, one in which one or more of the engine features are modified, or added, to increase the output of the operating cylinders in DOD operation. Preferably, this can be accomplished without significantly decreasing engine performance in STD operation and without excessive cost.

Some examples of engine components that may be modified are as follows.

The engine camshaft(s) may be redesigned to provide improved valve timing for increased efficiency in the DOD operating range.

The valve timing setting may be changed or made variable to provide a similar result.

The intake manifold and air system may be tuned to enhance torque output in the DOD operating range.

The exhaust system may also be tuned to enhance DOD torque.

A cam phaser may be used to adjust valve timing for optimal DOD performance.

A small supercharger (compressor) may be added for operation only during higher load ranges of DOD operation to increase the operating cylinder torque and power and extend the range of DOD operation. Any suitable means of driving the supercharger may be used, e.g. electrical, mechanical, hydraulic, or engine exhaust.

Additional modifications and additions of engine components for practicing the invention will no doubt become obvious to those skilled in the art.

These and other features and advantages of the invention will be more fully understood from the following description of certain specific embodiments of the invention taken together with the accompanying drawings.

### BRIEF DESCRIPTION OF THE DRAWINGS

FIG. 1 is a cross-sectional view of a single camshaft cylinder deactivation (DOD™) engine having cam timing in accordance with the invention;

FIG. 2 is a pictorial view of a double overhead camshaft engine with a cam phaser for varying cam timing;

FIG. 3 is a schematic diagram of a first embodiment of a cylinder air intake system;

FIG. 4 is a diagram of a second embodiment of air intake system;

FIG. 5 is a diagram of a third embodiment of air intake system;

FIG. 6 is a graph showing torque vs. engine speed for several exemplary intake system embodiments;

FIG. 7 is a schematic cross-sectional view of a variable runner length intake manifold;

FIG. 8 is a graph of mean effective pressure vs. engine speed for differing manifold runner lengths;

FIG. 9 is an exploded pictorial view of a variable length runner manifold;

FIG. 10 is a graph of brake torque vs. engine speed comparing DOD-tuned manifold runners with conventional runner tuning; and

FIG. 11 is a graph of volumetric efficiency vs. engine speed for the manifold runners of FIG. 10.

### DESCRIPTION OF THE PREFERRED EMBODIMENT

Referring now to the drawings in detail, numeral 10 generally indicates an automotive V8 cylinder deactivation (DOD™) engine shown in cross section and having a cam-in-block overhead valve train. The engine is modified to include at least one feature according to the present invention and is adapted to include additional or alternative other features.

Engine 10 includes a cylinder block 12 having left and right cylinder banks 14, 16 each including four cylinders 18. The banks are arranged at a ninety degree angle. The cylinders 18 carry pistons 20 which are reciprocated in the cylinders through connection by connecting rods 22 with a crankshaft 24. An oil pan 26 is mounted below the cylinder block 12 and is adapted to contain oil for delivery through an engine driven oil pump 28 to the various moving components of the engine.

As indicated in a displaced portion of the figure, the crankshaft 24 is connected at a front end, not shown, of the engine with a drive sprocket 30. A chain 32 connects the drive sprocket with a driven sprocket 34 mounting a cam phaser 36. The cam phaser connects with a camshaft 38 mounted within the cylinder block 12. The camshaft 38 includes a plurality of cam lobes 40 that are operative to reciprocate valve lifters 42, 44 which act through push rods 46 and rocker arms 48 to actuate exhaust and intake valves 50, 52, respectively, of the engine cylinders 18.

The rocker arms and valves are mounted in cylinder heads 54, 56 carried on the selected cylinder banks 14, 16, respectively, and closing the upper ends of the cylinders 18 of the respective banks.

An intake manifold 58 supplies intake air and fuel injectors 60 supply fuel to cylinder intake ports 62 which are controlled by the intake valves 52 to allow timed admission of the air and fuel mixture into the cylinders. Exhaust valves 50 are operated in like manner to control the discharge of combustion products from the cylinders through cylinder exhaust ports 64.

Selected engine cylinders, including at least half the engine cylinders, are provided with so called switching lifters 42, 44 for actuating the intake and the exhaust valves. The lifters of the other engine cylinders may be conventional hydraulic lifters or, if desired, could also utilize switching lifters as do the selected cylinders. The switching lifters when actuated operate to deactivate the valves of selected cylinders so that operation of the selected cylinders is cut out completely and the engine operates on the remaining cylinders. Fuel injection into the cylinders is also discontinued when the cylinders are cut out by actuation of the switching lifters. A solenoid control valve 66 may be provided to control the oil pressure supplied to the deactivation portion of the switching lifters to change their mode of operation between normal powered operation and non-powered cylinder cutout.

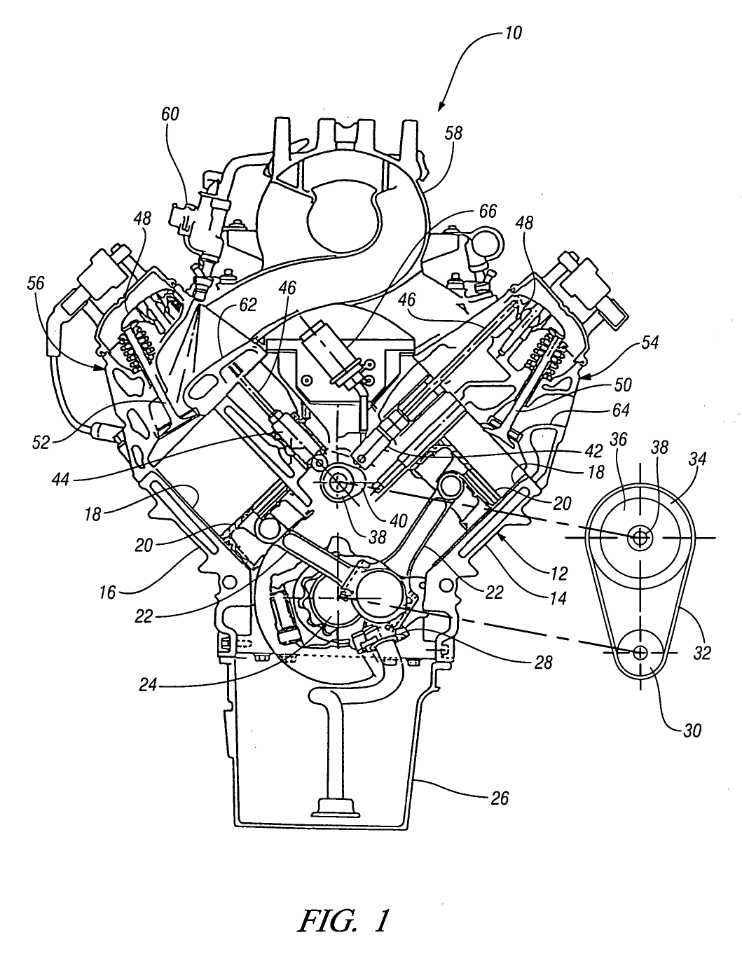

Referring still to FIG. 1 of the drawings, engine 10 may be modified according to the invention by designing the camshaft 38 so that the cams are timed for maximum torque at a mid range engine speed near the upper range of normal DOD operation instead of designing the cams for maximum power and torque at high engine speed in order to develop maximum horsepower from the engine. Redesign of the camshaft in this way increases the torque which may be developed by the engine when it is operating in the DOD mode with half of the cylinders cut out.

The modified camshaft timing allows the remaining active cylinders to operate at higher torque levels with greater volumetric efficiency and so allows the engine to develop higher power output in the DOD mode instead of requiring switchover to standard (STD) operation with all cylinders firing when a slight increase in torque from the normal DOD load limit is required. The result is that the engine can operate through more of its normal operating speeds and loads with only four of the cylinders providing power, which will yield increased efficiency for normal engine operation and at higher load levels then would be the case with normal camshaft timing.

Since the engine is also provided with an optional cam phaser 36, the operating characteristics of the engine may be further improved by varying the cam timing in order to provide best operation, not only in the DOD mode but also with all cylinders firing where adjustment of cam timing may provide increased engine output. However, with the single camshaft arrangement of engine 10 the cam phaser cannot provide any variation in the exhaust to intake valve overlap, which is fixed by the use of the single cam.

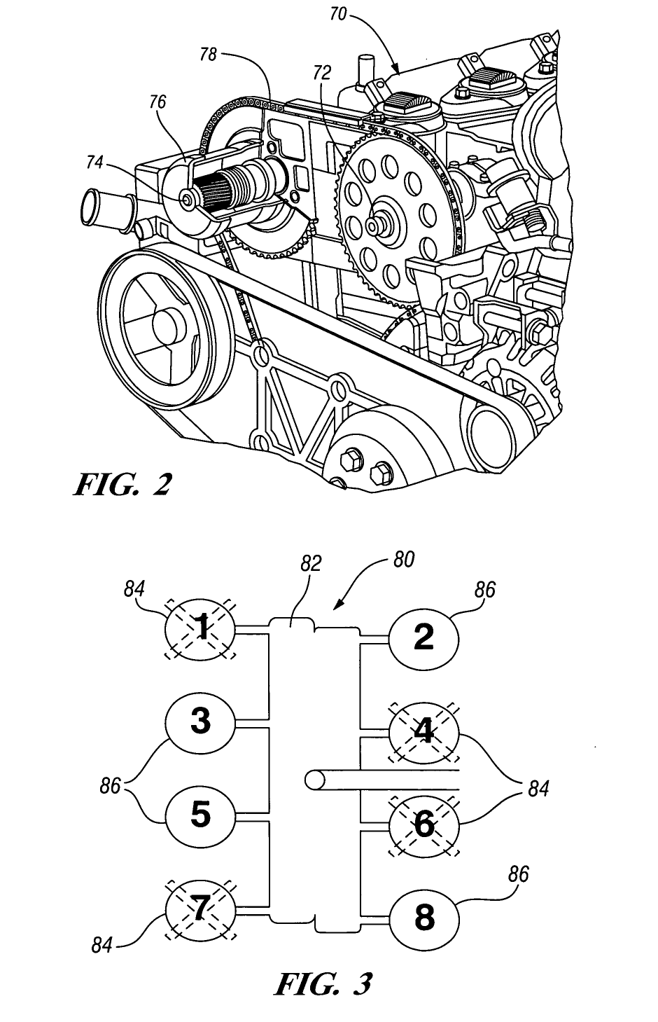

Referring now to FIG. 2, there is shown a portion of an overhead cam engine 70 which has a fixed exhaust camshaft 72 for operating the exhaust valves and a separate intake camshaft 74 for operating the intake valves, not shown. A cam phaser 76 is mounted on the end of the intake camshaft 74 and is driven by a timing chain 78 which also drives the exhaust camshaft 72.

Engine 70 is also provided with switching lifters, not shown, which allow the engine to run with cylinder deactivation (DOD) operation. The arrangement allows the cam phaser to be operated so that the valve overlap between exhaust and intake valves may be varied in DOD operation, as well as in normal operation, to provide maximum torque output over the speed range of DOD operation. This allows extended operation, in the DOD mode at higher engine speeds or greater loads without requiring shifting to the STD operating mode.

FIGS. 3-5 illustrate three alternative embodiments of intake manifold arrangements for V8 engines tested for providing tuning of air intake pulsations to determine their effect on increasing engine torque in the upper range of DOD operation. FIG. 3 depicts an engine 80 having a common manifold plenum 82 that connects with all eight cylinders of the engine. Cylinders 84 are DOD cylinders which are cut out during DOD operation and cylinders 86 are STD cylinders which continue operation in all conditions.

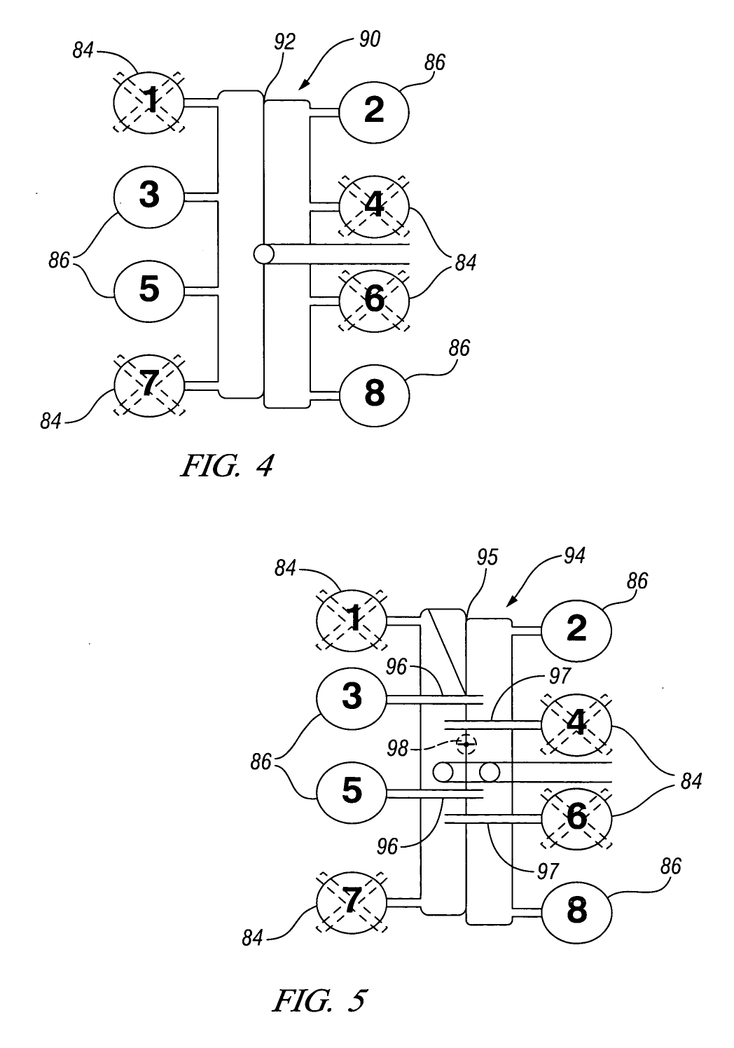

FIG. 4 depicts an engine 90 having a manifold with a divided plenum 92 in which one side of the plenum supplies intake air to the cylinders 84, 86 of one cylinder bank and the other side of the plenum supplies intake air to the cylinders 84, 86 of the other cylinder bank.

FIG. 5 illustrates still another manifold arrangement for an engine 94 having a divided plenum 95 with internal runners 96, 97 connected so that all the DOD cylinders 84 are fed by one side of the plenum and all the STD cylinders 86 are fed by the other side of the plenum 95. Thus, in DOD operation of this arrangement, all the operating cylinders 86 are fed intake air from the same side of the plenum.

In contrast, in the arrangement of FIG. 4, the four cylinders 86 active during DOD operation are fed two from one side of the plenum 92 and the other two from the other side of the plenum. FIG. 3 differs in that all the engine cylinders are fed from the same plenum 82, so that in DOD operation the operating cylinders 86 are again fed from the same plenum 82, which is larger than the half plenums of the other two embodiments.

As an alternative arrangement, the embodiment of FIG. 5 includes an opening with a shutoff valve 98 between the sides of plenum 95. The valve 98 can be opened when desired to join the sides of the plenum to form a single open chamber in the plenum 95. During DOD operation, the valve 98 may be closed or opened as needed in order to provide the desired tuning to increase the engine torque during DOD operation.

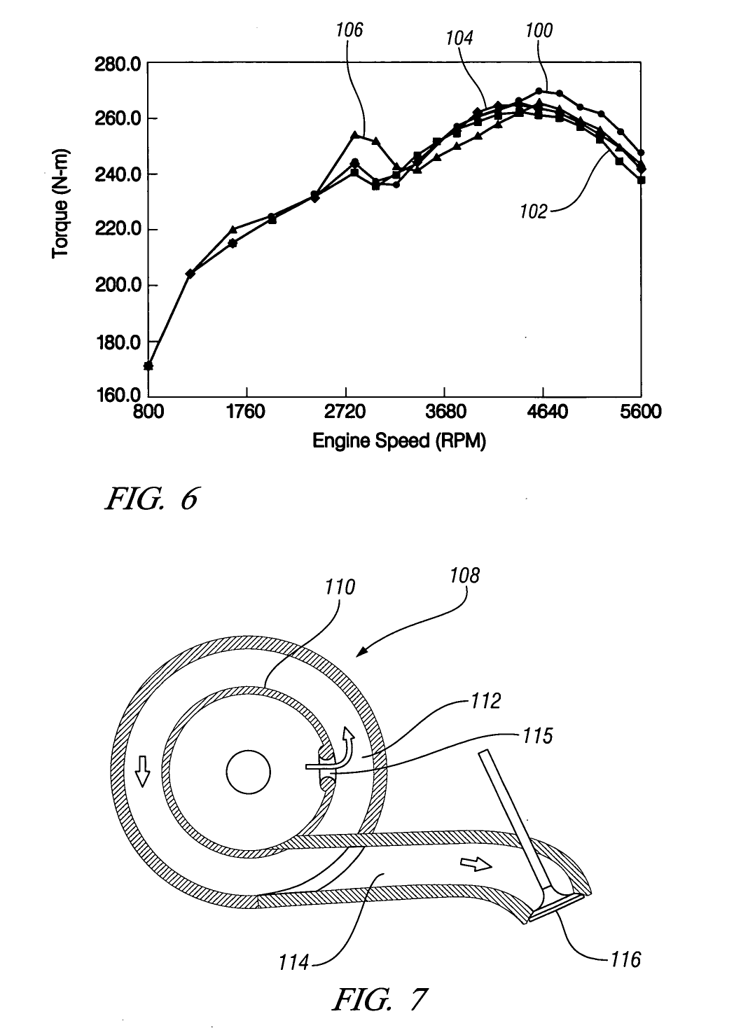

FIG. 6 is a graph illustrating the results of tests carried out on the four engine manifold arrangements just described and illustrated in FIGS. 3-5. The graph indicates the wide open throttle torque obtained during engine operation of the four embodiments while operating in the DOD mode over the range of engine speeds from 800 to 5600 RPM.

In the graph, line 100 represents the embodiment of FIG. 3, line 102 represents the embodiment of FIG. 4, line 104 represents the embodiment of FIG. 5 without use of the shutoff valve 98, and line 106 represents the embodiment of FIG. 5, with use of the shutoff valve 98. It should be noted that the embodiment of FIG. 5, represented by line 106, provides the highest midrange peak torque output, which is useful for increasing the range of DOD operation. The embodiment of FIG. 3, represented by line 100, provides the highest upper speed range torque, but otherwise falls below, or runs approximately with, the torque curves 102 and 104 for the other two embodiments.

These results are presented to indicate how varying the size and makeup of the intake manifold plenum or plenums can be used to vary engine output of the operating cylinders while operating in the DOD mode. Which arrangement would provide the best results for improved DOD operation in a particular engine would of course need to be determined by testing of various arrangements, or through sophisticated computer modeling.

Referring now to FIG. 7, another variation of an engine intake manifold 108 is shown wherein a rotatable drum 110 forms a plenum within a housing 112. The drum 110 is rotatable to vary the effective length of the runners 114 extending from an opening 115 in the interior of the drum to an associated intake valve 116. With this arrangement, the lengths of the runners may be varied with engine speed to provide a cylinder air charge pressure tuning peak that moves in concert with changes in engine speed to provide increased charge air to the cylinders over an extended range of engine speeds.

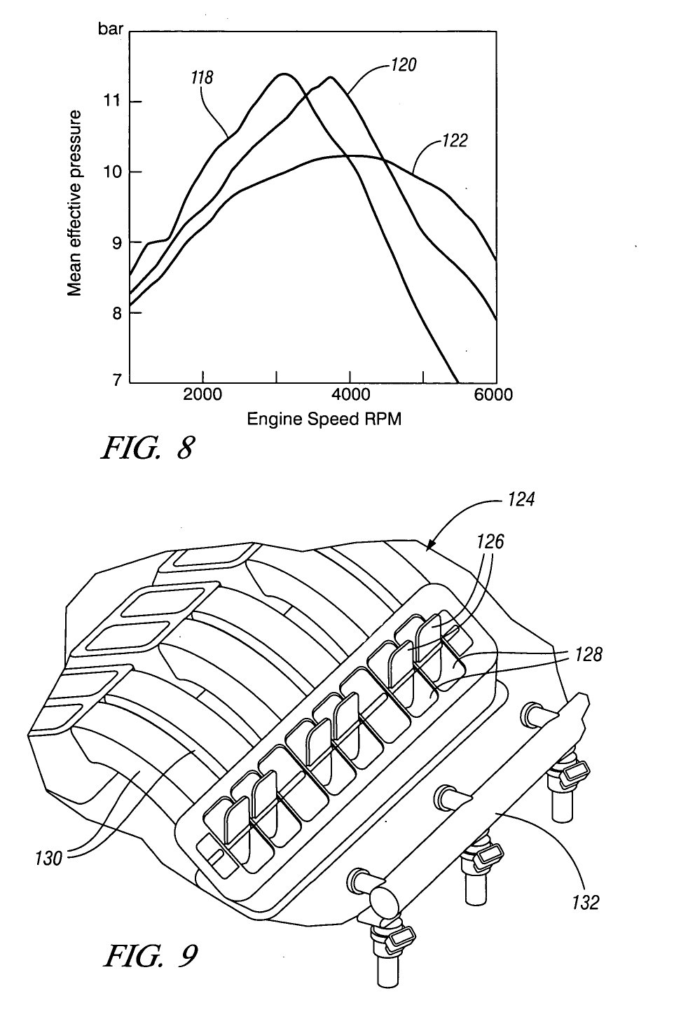

FIG. 8 is a graph indicating variations in mean effective pressure vs. engine speed for an engine tested with manifolds having differing runner lengths, and in one case, runner diameters. In the graph, line 118 indicates performance of the manifold with the longest runners which provided an operating torque peak at the lowest engine speed, slightly below 3000 RPM. Line 120 illustrates performance of a second manifold having runners approximately two thirds the length of the longer runners and providing a torque peak at a slightly higher speed, around 3500 RPM.

Line 122 indicates the performance of a manifold with short runners, about half the length and of slightly greater diameter than the embodiment represented by line 120. In this case the torque peak occurs at about 4000 RPM and is in general lower and more constant over the speed range than the other two embodiments.

It might be concluded from these results that a manifold with the longer runners would be chosen for DOD operation if having a torque peak near the midrange of engine operation provides the best overall operation of the engine in its particular application.

FIG. 9 illustrates a manifold 124 having changeable runner lengths provided by valves 126 in each of the runners 128 to direct intake flow either through long runner tubes 130 or, alternatively, shutting off these tubes and opening short passages in an alternative intake header 132. Such a manifold allows operation in lower speed ranges with the valves 126 open to give the benefit of a high peak torque at midrange engine speeds produced by the long runner lengths.

A high peak torque at high engine speeds is obtained by closing the valves and opening the header 132 to provide short runner passages. Many other alternative forms of variable length and multiple length runner passages in manifold arrangements may be utilized for developing a proper balance of midrange peak torque for DOD operation and high range peak torque for STD operation with all cylinders producing power.

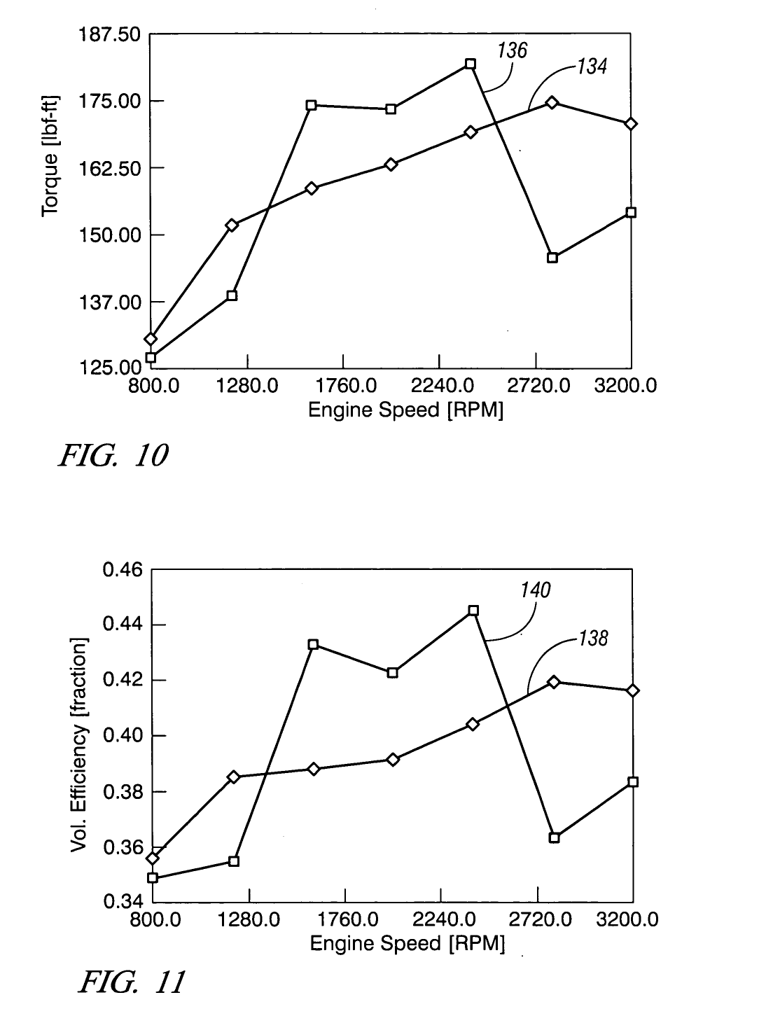

Referring now to FIG. 10, there is shown a graph of brake torque vs. engine speed for an engine wherein line 134 represents test results using a conventional manifold arrangement designed for smoothly increasing torque with increasing engine speed. Line 136 indicates the results of a manifold having the intake runner lengths tuned for a peak midrange torque curve which rises rapidly to a peak in a range extending from about 1200 RPM to about 2500 RPM with relatively low torque above and below this range. Such an arrangement provides increased torque for DOD operation in the lower and middle range of engine speeds, but yields less favorable operation at higher speeds.

For comparison, FIG. 11 is a graph showing volumetric efficiency vs. engine speed for the same engine tests indicated in FIG. 10. In this FIG. 11, line 138 indicates the conventional manifold with smooth torque and volumetric efficiency curves while line 140 represents the tuned manifold with the midrange high peak torque and volumetric efficiency. It is apparent that, in the midrange operation with DOD, engine efficiency would be dramatically improved by this arrangement but that changes would be desired to obtain high efficiency in engine operation beyond the speed range indicated as highly efficient in this case.

The foregoing illustrations, showing various features capable of being utilized in DOD engines as illustrated in FIGS. 1-11, are examples of features which may be used separately or in combination with a DOD engine to improve DOD operating performance and extend the DOD operating range to higher loads and speeds without requiring switching to STD operation.

Not shown in the drawings are possible additional features, such as tuning of the engine exhaust system which may be capable of increasing engine air flow at predetermined engine operating speeds by reducing exhaust pressure at the exhaust ports through wave action in the exhaust manifold system. An additional possibility, not illustrated, is the addition of a small supercharger connected to the STD cylinders of a DOD engine. The supercharger is utilized temporarily to provide increased cylinder intake air pressure when the engine is operating in the DOD mode and near the maximum normal torque output level, so that an increase in available torque is provided allowing a slight increase in engine power without requiring changeover to the STD operating mode.

The present invention as described herein departs from conventionally tuned or equipped DOD engines by providing an increased torque peak in a range near and above the high end of DOD normal operation so that the range of DOD operation may be extended to higher torque and speed levels that would otherwise not be obtainable.

While the invention has been described by reference to certain preferred embodiments, it should be understood that numerous changes could be made within the spirit and scope of the inventive concepts described. Accordingly, it is intended that the invention not be limited to the disclosed embodiments, but that it have the full scope permitted by the language of the following claims.

1. An engine including cylinder deactivation (DOD™) wherein the engine is operable with power generated by less than all of the cylinders in a DOD range of speeds and loads providing increased efficiency with less than maximum performance, and the improvement of performance enhancing equipment effective to provide a high level of engine torque that extends the DOD range, said equipment comprising at least one of the group consisting of a camshaft, valve timing means, an intake air system, an exhaust system, a cam phaser, and a supercharger.

2. An engine as in claim 1 wherein the camshaft is designed to enhance engine torque in the DOD range.

3. An engine as in claim 1 wherein the valve timing means is operative to enhance engine torque in the DOD range.

4. An engine as in claim 1 wherein the intake air system is tuned to enhance engine torque in the DOD range.

5. An engine as in claim 1 wherein the exhaust system is tuned to enhance engine torque in the DOD range.

6. An engine as in claim 1 wherein the cam phaser as applied is designed to enhance engine torque in the DOD range.

7. An engine as in claim 1 wherein the supercharger is operable to enhance engine torque produced by the operating cylinders during DOD operation.

8. A method operating an engine with power generated by less than all of the cylinders in a DOD range of speeds and loads providing increased efficiency with less than maximum performance, the method comprising:
extending the DOD range by equipping the engine for increased torque output in the DOD range, and
extending DOD operation of the engine into a higher range of speeds and loads.

10. A method as in claim 9 wherein the DOD range is extended by selective tuning of the engine intake air system.

11. A method as in claim 9 wherein the DOD range is extended by selective tuning of the engine exhaust system.

12. A method as in claim 9 wherein the DOD range is extended by preferential selection of the engine valve timing.

13. A method as in claim 9 wherein the DOD range is extended by selectively supercharging the operating cylinders as needed to avoid switchover to STD mode with all cylinders operating.
